(19) United States
(12) Patent Application Publication
(10) Pub. No.: US 2023/0115309 A1
(43) Pub. Date: Apr. 13, 2023

(54) ELECTRONIC DEVICE AND UTTERANCE PROCESSING METHOD OF THE ELECTRONIC DEVICE

(71) Applicant: Samsung Electronics Co., Ltd., Gyeonggi-do (KR)

(72) Inventors: Taegu KIM, Gyeonggi-do (KR); Jimin LEE, Gyeonggi-do (KR)

(21) Appl. No.: 17/950,339

(22) Filed: Sep. 22, 2022

(30) Foreign Application Priority Data
Oct. 8, 2021 (KR) 10-2021-0134093

(51) Int. Cl. G10L 15/22; G10L 15/30

(52) U.S. Cl. CPC G10L 15/22; G10L 15/30; G10L 2015/223

(57) ABSTRACT

According to an embodiment, an electronic device comprises: a microphone; a processor; and a memory storing instructions executable by the processor, wherein execution of the instructions by the processor causes the processor to perform a plurality of operations comprising: receiving an audio signal including an utterance of a user from the microphone; obtaining information on an application and information on a goal for processing the utterance, determining whether to process the utterance with the electronic device or with a server, based on the information on the application, the information on the goal, and version information received from the server, determining whether to update the information on the application and the information on the goal based on the version information, the information on the application, and the information on the goal; when determining to process the utterance at the electronic device, processing the utterance; and when determining to process the utterance at the server, transmitting the utterance to the server.

### CROSS-REFERENCE TO RELATED APPLICATIONS

This application claims the benefit under 35 USC § 119(a) of Korean Patent Application No. 10-2021-0134093, filed on Oct. 8, 2021, in the Korean Intellectual Property Office, the entire disclosure of which is incorporated herein by reference for all purposes.

### BACKGROUND

### 1. Field

The disclosure relates to an electronic device and an utterance processing method of the electronic device.

### 2. Description of Related Art

Recent electronic devices may support various input methods such as voice input. For example, electronic devices such as smartphones or tablets may recognize an utterance of a user input while a speech recognition service is running. In response, the electronic device may execute an operation corresponding to the input utterance.

The processing of the utterance may be performed through an on-device service or a server. When an utterance processing service is provided by a combination of the on-device service and the server, the user experience for the same utterance may be different. The user experience may be different because a result processed by the on-device and a result processed by the server may be different.

### SUMMARY

According to one embodiment, when an utterance is received, a latest user experience may be provided to the user by maintaining the latest version through syncing the electronic device and the server.

The technical goals to be achieved are not limited to those described above, and other technical goals not mentioned above will be clearly understood by one of ordinary skill in the art from the following description.

According to an embodiment, an electronic device comprises: a microphone; a processor; and a memory storing instructions executable by the processor, wherein execution of the instructions by the processor causes the processor to perform a plurality of operations comprising: receiving an audio signal including an utterance of a user from the microphone; obtaining information on an application and information on a goal for processing the utterance, determining whether to process the utterance with the electronic device or with a server, based on the information on the application, the information on the goal, and version information received from the server, determining whether to update the information on the application and the information on the goal based on the version information, the information on the application, and the information on the goal; when determining to process the utterance at the electronic device, processing the utterance; and when determining to process the utterance at the server, transmitting the utterance to the server.

According to an embodiment, an electronic device comprises: a microphone; a processor; and a memory storing instructions that are executable by the processor, wherein execution of the instructions by the processor causes the processor to perform a plurality of operations comprising: receiving an audio signal including an utterance of a user from the microphone; obtaining information on an application and information on a goal for processing the utterance, determining whether the electronic device can process the utterance based on the information on the application, the information on the goal, and version information received from a server, and updating of the information on the application and the information on the goal based on whether the processing is possible.

According to an embodiment, a method for processing an utterance, comprises: receiving an audio signal including an utterance of a user; obtaining information on an application and information on a goal for processing the utterance based on the audio signal; determining whether to process the utterance at an electronic device or a server based on the information on the application, the information on the goal, and version information received from the server; and determining whether to update the information on the application and the information on the goal based on the version information, the information on the application, and the information on the goal.

According to one embodiment, an optimal service may be provided to a user of the electronic device by actively determining a subject that will process the utterance of the user.

According to one embodiment, the latest version of a user experience may be provided by maintaining synchronization between the electronic device and the server.

In addition, various effects directly or indirectly ascertained through the present disclosure may be provided.

### BRIEF DESCRIPTION OF THE DRAWINGS

The above and other aspects, features, and advantages of certain embodiments of the present disclosure will be more apparent from the following detailed description, taken in conjunction with the accompanying drawings, in which:

FIG. 1 is a block diagram illustrating an electronic device 101 in a network environment 100 according to one embodiment;

FIG. 2 is a block diagram illustrating an integrated intelligence system according to one embodiment;

FIG. 3 is a diagram illustrating a form in which relationship information between concepts and actions is stored in a database according to one embodiment;

FIG. 4 is a diagram illustrating a screen of an electronic device processing a received voice input through an intelligent app according to one embodiment;

FIG. 5 is a block diagram illustrating an electronic device according to one embodiment;

FIG. 6 is an example of a configuration of an utterance processing system according to one embodiment;

FIG. 7 is a diagram illustrating an operation of comparing information between an electronic device and a server according to one embodiment;

FIG. 8 is a flowchart illustrating an utterance processing operation of an electronic device according to one embodiment;

FIG. 9 is an example of a user interface according to one embodiment;

FIG. 10 is a flowchart illustrating a resource sync operation of an electronic device according one embodiment;

FIG. 11 is a flowchart illustrating an update operation of an electronic device according to one embodiment; and

FIG. 12 is a flowchart illustrating an operation of an electronic device according to one embodiment.

### DETAILED DESCRIPTION

Hereinafter, example embodiments will be described in detail with reference to the accompanying drawings. When describing the example embodiments with reference to the accompanying drawings, like reference numerals refer to like elements and any repeated description related thereto will be omitted.

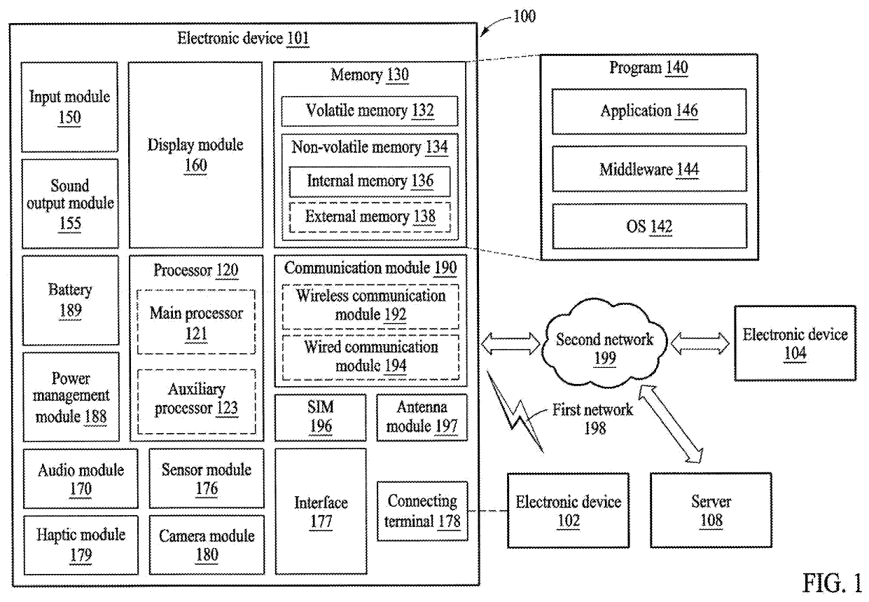

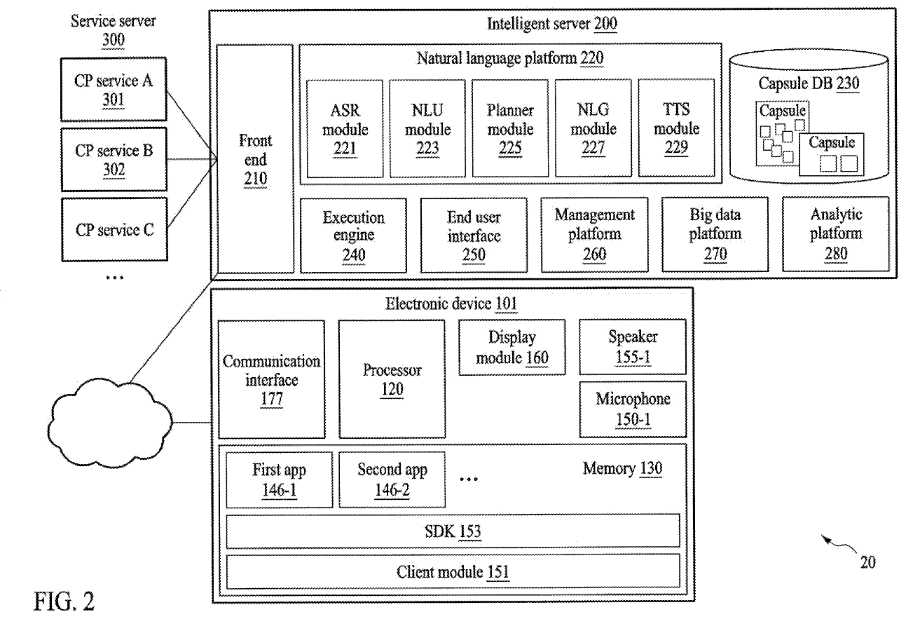

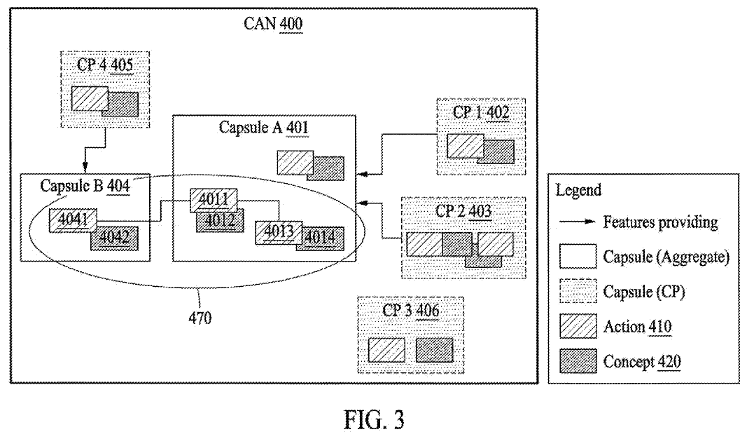

FIG. 1 describes an electronic device wherein certain embodiments of this disclosure can be practiced. For example, the electronic device 101 can receive a voice input. The electronic device 101 can use an intelligent server 200 to determine a command associated with the voice input. FIGS. 2 and 3 describe an intelligent server.

Electronic Device

FIG. 1 is a block diagram illustrating an electronic device 101 in a network environment 100 according to one embodiment. Referring to FIG. 1, the electronic device 101 in the network environment 100 may communicate with an electronic device 102 via a first network 198 (e.g., a short-range wireless communication network), or communicate with at least one of an electronic device 104 and a server 108 via a second network 199 (e.g., a long-range wireless communication network). According to an example embodiment, the electronic device 101 may communicate with the electronic device 104 via the server 108. According to an example embodiment, the electronic device 101 may include a processor 120, a memory 130, an input module 150, a sound output module 155, a display module 160, an audio module 170, and a sensor module 176, an interface 177, a connecting terminal 178, a haptic module 179, a camera module 180, a power management module 188, a battery 189, a communication module 190, a subscriber identification module (SIM) 196, or an antenna module 197. In some example embodiments, at least one of the components (e.g., the connecting terminal 178) may be omitted from the electronic device 101, or one or more other components may be added to the electronic device 101. In some example embodiments, some of the components (e.g., the sensor module 176, the camera module 180, or the antenna module 197) may be integrated as a single component (e.g., the display module 160).

The processor 120 may execute, for example, software (e.g., a program 140) to control at least one other component (e.g., a hardware or software component) of the electronic device 101 connected to the processor 120, and may perform various data processing or computations. According to an example embodiment, as at least a part of data processing or computation, the processor 120 may store a command or data received from another component (e.g., the sensor module 176 or the communication module 190) in a volatile memory 132, process the command or the data stored in the volatile memory 132, and store resulting data in a non-volatile memory 134. According to an example embodiment, the processor 120 may include a main processor 121 (e.g., a central processing unit (CPU) or an application processor (AP)), or an auxiliary processor 123 (e.g., a graphics processing unit (GPU), a neural processing unit (NPU), an image signal processor (ISP), a sensor hub processor, or a communication processor (CP)) that is operable independently from, or in conjunction with the main processor 121. For example, when the electronic device 101 includes the main processor 121 and the auxiliary processor 123, the auxiliary processor 123 may be adapted to consume less power than the main processor 121 or to be predetermined to a specified function. The auxiliary processor 123 may be implemented separately from the main processor 121 or as a part of the main processor 121.

The term “processor” shall be understood to refer to both the singular and plural contexts in this document.

The auxiliary processor 123 may control at least some of functions or states related to at least one (e.g., the display module 160, the sensor module 176, or the communication module 190) of the components of the electronic device 101, instead of the main processor 121 while the main processor 121 is in an inactive (e.g., sleep) state or along with the main processor 121 while the main processor 121 is an active state (e.g., executing an application). According to an example embodiment, the auxiliary processor 123 (e.g., an ISP or a CP) may be implemented as a portion of another component (e.g., the camera module 180 or the communication module 190) that is functionally related to the auxiliary processor 123. According to an example embodiment, the auxiliary processor 123 (e.g., an NPU) may include a hardware structure specifically for artificial intelligence model processing. An artificial intelligence model may be generated by machine learning. The machine learning may be performed by, for example, the electronic device 101, in which artificial intelligence is performed, or performed via a separate server (e.g., the server 108). Learning algorithms may include, but are not limited to, for example, supervised learning, unsupervised learning, semi-supervised learning, or reinforcement learning algorithms. The artificial intelligence (AI) model may include a plurality of artificial neural network layers. An artificial neural network may include, for example, a deep neural network (DNN), a convolutional neural network (CNN), a recurrent neural network (RNN), a restricted Boltzmann machine (RBM), a deep belief network (DBN), and a bidirectional recurrent deep neural network (BRDNN), a deep Q-network, or a combination of two or more thereof, but is not limited thereto. The AI model may additionally or alternatively include a software structure other than the hardware structure.

The memory 130 may store various pieces of data used by at least one component (e.g., the processor 120 or the sensor module 176) of the electronic device 101. The various pieces of data may include, for example, software (e.g., the program 140) and input data or output data for a command related thereto. The memory 130 may include the volatile memory 132 or the non-volatile memory 134.

The program 140 may be stored as software in the memory 130, and may include, for example, an operating system (OS) 142, middleware 144, or an application 146.

The input module 150 may receive, from outside (e.g., a user) the electronic device 101, a command or data to be used by another component (e.g., the processor 120) of the electronic device 101. The input module 150 may include, for example, a microphone, a mouse, a keyboard, a key (e.g., a button), or a digital pen (e.g., a stylus pen).

The sound output module 155 may output a sound signal to the outside of the electronic device 101. The sound output module 155 may include, for example, a speaker or a receiver. The speaker may be used for general purposes, such as playing multimedia or playing a recording. The receiver may be used to receive an incoming call. According to an example embodiment, the receiver may be implemented separately from the speaker or as a part of the speaker.

The display module 160 may visually provide information to the outside (e.g., a user) of the electronic device 101. The display module 160 may include, for example, a control circuit for controlling a display, a hologram device, or a projector and control circuitry to control its corresponding one of the display, the hologram device, and the projector. According to an example embodiment, the display module 160 may include a touch sensor adapted to detect a touch, or a pressure sensor adapted to measure the intensity of force of the touch.

The audio module 170 may convert sound into an electric signal or vice versa. According to an example embodiment, the audio module 170 may obtain the sound via the input module 150 or output the sound via the sound output module 155 or an external electronic device (e.g., the electronic device 102 such as a speaker or headphones) directly or wirelessly connected to the electronic device 101.

The sensor module 176 may detect an operational state (e.g., power or temperature) of the electronic device 101 or an environmental state (e.g., a state of a user) external to the electronic device 101, and generate an electric signal or data value corresponding to the detected state. According to an example embodiment, the sensor module 176 may include, for example, a gesture sensor, a gyro sensor, an atmospheric pressure sensor, a magnetic sensor, an acceleration sensor, a grip sensor, a proximity sensor, a color sensor, an infrared (IR) sensor, a biometric sensor, a temperature sensor, a humidity sensor, or an illuminance sensor.

The interface 177 may support one or more specified protocols to be used by the electronic device 101 to couple with the external electronic device (e.g., the electronic device 102) directly (e.g., by wire) or wirelessly. According to an example embodiment, the interface 177 may include, for example, a high-definition multimedia interface (HDMI), a universal serial bus (USB) interface, a secure digital (SD) card interface, or an audio interface.

The connecting terminal 178 may include a connector via which the electronic device 101 may physically connect to an external electronic device (e.g., the electronic device 102). According to an example embodiment, the connecting terminal 178 may include, for example, an HDMI connector, a USB connector, an SD card connector, or an audio connector (e.g., a headphones connector).

The haptic module 179 may convert an electric signal into a mechanical stimulus (e.g., a vibration or a movement) or an electrical stimulus which may be recognized by a user via their tactile sensation or kinesthetic sensation. According to an example embodiment, the haptic module 179 may include, for example, a motor, a piezoelectric element, or an electric stimulator.

The camera module 180 may capture a still image and moving images. According to an example embodiment, the camera module 180 may include one or more lenses, image sensors, ISPs, and flashes.

The power management module 188 may manage power supplied to the electronic device 101. According to an example embodiment, the power management module 188 may be implemented as, for example, at least a part of a power management integrated circuit (PMIC).

The battery 189 may supply power to at least one component of the electronic device 101. According to an example embodiment, the battery 189 may include, for example, a primary cell which is not rechargeable, a secondary cell which is rechargeable, or a fuel cell.

The communication module 190 may support establishing a direct (e.g., wired) communication channel or a wireless communication channel between the electronic device 101 and the external electronic device (e.g., the electronic device 102, the electronic device 104, or the server 108) and performing communication via the established communication channel. The communication module 190 may include one or more CPs that are operable independently from the processor 120 (e.g., an AP) and that support direct (e.g., wired) communication or wireless communication. According to an example embodiment, the communication module 190 may include a wireless communication module 192 (e.g., a cellular communication module, a short-range wireless communication module, or a global navigation satellite system (GNSS) communication module) or a wired communication module 194 (e.g., a local area network (LAN) communication module, or a power line communication (PLC) module). A corresponding one of these communication modules may communicate with the external electronic device, for example, the electronic device 104, via the first network 198 (e.g., a short-range communication network, such as Bluetooth™, wireless-fidelity (Wi-Fi) direct, or infrared data association (IrDA)) or the second network 199 (e.g., a long-range communication network, such as a legacy cellular network, a 5G network, a next-generation communication network, the Internet, or a computer network (e.g., a LAN or a wide area network (WAN))). These various types of communication modules may be implemented as a single component (e.g., a single chip), or may be implemented as multiple components (e.g., multiple chips) separate from each other. The wireless communication module 192 may identify and authenticate the electronic device 101 in a communication network, such as the first network 198 or the second network 199, using subscriber information (e.g., international mobile subscriber identity (IMSI)) stored in the SIM 196.

The wireless communication module 192 may support a 5G network after a 4G network, and next-generation communication technology, for example, new radio (NR) access technology. The NR access technology may support enhanced mobile broadband (eMBB), massive machine type communications (mMTC), or ultra-reliable and low-latency communications (URLLC). The wireless communication module 192 may support a high-frequency band (e.g., a mmWave band) to achieve, e.g., a high data transmission rate. The wireless communication module 192 may support various technologies for securing performance on a high-frequency band, such as, e.g., beamforming, massive multiple-input and multiple-output (MIMO), full dimensional MIMO (FD-MIMO), an array antenna, analog beam-forming, or a large scale antenna. The wireless communication module 192 may support various requirements specified in the electronic device 101, an external electronic device (e.g., the electronic device 104), or a network system (e.g., the second network 199). According to an example embodiment, the wireless communication module 192 may support a peak data rate (e.g., 20 Gbps or more) for implementing eMBB, loss coverage (e.g., 164 dB or less) for implementing mMTC, or U-plane latency (e.g., 0.5 ms or less for each of downlink (DL) and uplink (UL), or a round trip of 1 ms or less) for implementing URLLC.

The antenna module 197 may transmit or receive a signal or power to or from the outside (e.g., the external electronic device) of the electronic device 101. According to an example embodiment, the antenna module 197 may include an antenna including a radiating element including a conductive material or a conductive pattern formed in or on a substrate (e.g., a printed circuit board (PCB)). According to an example embodiment, the antenna module 197 may include a plurality of antennas (e.g., an antenna array). In such a case, at least one antenna appropriate for a communication scheme used in a communication network, such as the first network 198 or the second network 199, may be selected by, for example, the communication module 190 from the plurality of antennas. The signal or power may be transmitted or received between the communication module 190 and the external electronic device via the at least one selected antenna. According to an example embodiment, another component (e.g., a radio frequency integrated circuit (RFIC)) other than the radiating element may be additionally formed as a part of the antenna module 197.

The antenna module 197 may form a mmWave antenna module. The mmWave antenna module may include a PCB, an RFIC on a first surface (e.g., the bottom surface) of the PCB, or adjacent to the first surface of the PCB and capable of supporting a designated high-frequency band (e.g., a mmWave band), and a plurality of antennas (e.g., array antennas) disposed on a second surface (e.g., the top or a side surface) of the PCB, or adjacent to the second surface of the PCB and capable of transmitting or receiving signals of the designated high-frequency band.

At least some of the above-described components may be coupled mutually and exchange signals (e.g., commands or data) therebetween via an inter-peripheral communication scheme (e.g., a bus, general purpose input and output (GPIO), serial peripheral interface (SPI), or mobile industry processor interface (MIPI)).

Commands or data may be transmitted or received between the electronic device 101 and the external electronic device (e.g., the electronic device 104) via the server 108 coupled with the second network 199. Each of the external electronic devices (e.g., the electronic device 102 or 104) may be a device of the same type as or a different type from the electronic device 101. All or some of operations to be executed by the electronic device 101 may be executed by one or more external electronic devices (e.g., the external devices 102 and 104, and the server 108). For example, if the electronic device 101 needs to perform a function or a service automatically, or in response to a request from a user or another device, the electronic device 101, instead of, or in addition to, executing the function or the service, may request the one or more external electronic devices to perform at least part of the function or service. The one or more external electronic devices receiving the request may perform the at least part of the function or service, or an additional function or an additional service related to the request, and may transfer a result of the performance to the electronic device 101. The electronic device 101 may provide the result, with or without further processing the result, as at least part of a response to the request. To that end, cloud computing, distributed computing, mobile edge computing (MEC), or client-server computing technology may be used, for example. The electronic device 101 may provide ultra low-latency services using, for example, distributed computing or MEC. In an embodiment, the external electronic device (e.g., the electronic device 104) may include an Internet-of-things (IoT) device. The server 108 may be an intelligent server using machine learning and/or a neural network. According to an embodiment, the external electronic device (e.g., the electronic device 104) or the server 108 may be included in the second network 199. The electronic device 101 may be applied to intelligent services (e.g., a smart home, a smart city, a smart car, or healthcare) based on 5G communication technology or IoT-related technology.

The electronic device according to certain embodiments may be one of various types of electronic devices. The electronic device may include, for example, a portable communication device (e.g., a smartphone), a computer device, a portable multimedia device, a portable medical device, a camera, a wearable device, or a home appliance device. The electronic device according to an embodiment is not limited to those described above.

It should be understood that certain embodiments of the present disclosure and the terms used therein are not intended to limit the technological features set forth herein to particular embodiments and include various changes, equivalents, or replacements for a corresponding embodiment. In connection with the description of the drawings, like reference numerals may be used for similar or related components. It is to be understood that a singular form of a noun corresponding to an item may include one or more of the things, unless the relevant context clearly indicates otherwise. As used herein, “A or B”, “at least one of A and B”, “at least one of A or B”, “A, B or C”, “at least one of A, B and C”, and “A, B, or C,” each of which may include any one of the items listed together in the corresponding one of the phrases, or all possible combinations thereof. Terms such as “first”, “second”, or “first” or “second” may simply be used to distinguish the component from other components in question, and do not limit the components in other aspects (e.g., importance or order). It is to be understood that if an element (e.g., a first element) is referred to, with or without the term “operatively” or “communicatively”, as “coupled with,” “coupled to,” “connected with,” or “connected to” another element (e.g., a second element), it means that the element may be coupled with the other element directly (e.g., by wire), wirelessly, or via a third element.

As used in connection with certain embodiments of the disclosure, the term “module” may include a unit implemented in hardware, software, or firmware, and may interchangeably be used with other terms, for example, “logic,” “logic block,” “part,” or “circuitry”. A module may be a single integral component, or a minimum unit or part thereof, adapted to perform one or more functions. For example, according to an embodiment, the module may be implemented in a form of an application-specific integrated circuit (ASIC).

As set forth herein may be implemented as software (e.g., the program 140) including one or more instructions that are stored in a storage medium (e.g., the internal memory 136 or the external memory 138) that is readable by a machine (e.g., the electronic device 101). For example, a processor (e.g., the processor 120) of the machine (e.g., the electronic device 101) may invoke at least one of the one or more instructions stored in the storage medium, and execute it. This allows the machine to be operated to perform at least one function according to the at least one instruction invoked. The one or more instructions may include code generated by a compiler or code executable by an interpreter. The machine-readable storage medium may be provided in the form of a non-transitory storage medium. Here, the term “non-transitory” simply means that the storage medium is a tangible device, and does not include a signal (e.g., an electromagnetic wave), but this term does not differentiate between where data is semi-permanently stored in the storage medium and where the data is temporarily stored in the storage medium.

A method according to one embodiment of the disclosure may be included and provided in a computer program product. The computer program product may be traded as a product between a seller and a buyer. The computer program product may be distributed in the form of a machine-readable storage medium (e.g., a compact disc read-only memory (CD-ROM)), or be distributed (e.g., downloaded or uploaded) online via an application store (e.g., PlayStore™), or between two user devices (e.g., smartphones) directly. If distributed online, at least part of the computer program product may be temporarily generated or at least temporarily stored in the machine-readable storage medium, such as a memory of the manufacturer's server, a server of the application store, or a relay server.

Each component (e.g., a module or a program) of the above-described components may include a single entity or multiple entities, and some of the multiple entities may be separately disposed in different components. According to certain embodiments, one or more of the above-described components may be omitted, or one or more other components may be added. Alternatively or additionally, a plurality of components (e.g., modules or programs) may be integrated into a single component. In such a case, according to certain embodiments, the integrated component may still perform one or more functions of each of the plurality of components in the same manner or in a similar manner as they are performed by a corresponding one of the plurality of components before the integration. According to certain embodiments, operations performed by the module, the program, or another component may be carried out sequentially, in parallel, repeatedly, or heuristically, or one or more of the operations may be executed in a different order or omitted, or one or more other operations may be added.

In certain embodiments, the user may provide a voice command. The voice command is received by a microphone in the audio module 170. The voice command is recognized by the electronic device 101 or by the electronic device 101 in conjunction with a server 108.

Intelligence Server

FIG. 2 is a block diagram illustrating an integrated intelligence system according to an embodiment. The electronic device 101, in conjunction with the intelligent server 200 determines a command based on the user's voice. The electronic device 101 can receive a voice command from a user via microphone 150-1. A client module 151 provides the voice input to the intelligent server 200.

Referring to FIG. 2, an integrated intelligence system 20 according to an embodiment may include an electronic device (e.g., the electronic device 101 of FIG. 1), an intelligent server 200 (e.g., the server 108 of FIG. 1), and a service server 300 (e.g., the server 108 of FIG. 1).

The electronic device 101 may be a terminal device (or an electronic device) connectable to the Internet, and may be, for example, a mobile phone, a smartphone, a personal digital assistant (PDA), a notebook computer, a TV, a white home appliance, a wearable device, a head-mounted display (HMD), or a smart speaker.

The electronic device 101 may include a communication interface 177 (e.g., the interface 177 of FIG. 1), a microphone 150-1 (e.g., the input module 150 of FIG. 1), a speaker 155-1 (e.g., the sound output module 155 of FIG. 1), a display module 160 (e.g., the display module 160 of FIG. 1), a memory 130 (e.g., the memory 130 of FIG. 1), or a processor 120 (e.g., the processor 120 of FIG. 1). The components listed above may be operationally or electrically connected to each other.

The communication interface 177 may be connected to an external device and configured to transmit and receive data to and from the external device. The microphone 150-1 may receive a sound (e.g., a user utterance) and convert the sound into an electrical signal. The speaker 155-1 may output the electrical signal as a sound (e.g., a speech).

The display module 160 may be configured to display an image or video. The display module 160 may also display a graphical user interface (GUI) of an app (or an application program) being executed. The display module 160 may receive a touch input through a touch sensor. For example, the display module 160 may receive a text input through a touch sensor in an on-screen keyboard area displayed in the display module 160.

The memory 130 may store a client module 151, a software development kit (SDK) 153, and a plurality of apps 146 (e.g., the application 146 of FIG. 1). The client module 151 and the SDK 153 may configure a framework (or a solution program) for performing general-purpose functions. In addition, the client module 151 or the SDK 153 may configure a framework for processing a user input (e.g., a voice input, a text input, or a touch input).

The plurality of apps 146 stored in the memory 130 may be programs for performing designated functions. The plurality of apps 146 may include a first app 1461, a second app 1462, and the like. Each of the plurality of apps 146 may include a plurality of actions for performing a designated function. For example, the apps may include an alarm app, a messaging app, and/or a scheduling app. The plurality of apps 146 may be executed by the processor 120 to sequentially execute at least a portion of the plurality of actions.

The processor 120 may control the overall operation of the electronic device 101. For example, the processor 120 may be electrically connected to the communication interface 177, the microphone 150-1, the speaker 155-1, and the display module 160 to perform a designated operation.

The processor 120 may also perform the designated function by executing the program stored in the memory 130. For example, the processor 120 may execute at least one of the client module 151 or the SDK 153 to perform the following operation for processing a user input. The processor 120 may control the operation of the plurality of apps 146 through, for example, the SDK 153. The following operation which is the operation of the client module 151 or the SDK 153 may be performed by the processor 120.

The client module 151 may receive a user input. For example, the client module 151 may receive a voice signal corresponding to a user utterance sensed through the microphone 150-1. As another example, the client module 151 may receive a touch input sensed through the display module 160. As still another example, the client module 151 may receive a text input sensed through a keyboard or an on-screen keyboard. In addition, the client module 151 may receive various types of user inputs sensed through an input module included in the electronic device 101 or an input module connected to the electronic device 101. The client module 151 may transmit the received user input to the intelligent server 200. The client module 151 may transmit state information of the electronic device 101 together with the received user input to the intelligent server 200. The state information may be, for example, execution state information of an app.

The client module 151 may receive a result corresponding to the received user input. For example, when the intelligent server 200 is capable of calculating a result corresponding to the received user input, the client module 151 may receive the result corresponding to the received user input. The client module 151 may display the received result on the display module 160. Further, the client module 151 may output the received result in an audio form through the speaker 155-1.

The client module 151 may receive a plan corresponding to the received user input. The client module 151 may display results of executing a plurality of actions of an app according to the plan on the display module 160. For example, the client module 151 may sequentially display the results of executing the plurality of actions on the display module 160 and output the results in an audio form through the speaker 155-1. For example, the electronic device 101 may display only a portion of the results of executing the plurality of actions (e.g., a result of the last action) on the display module 160 and output the portion of the results in an audio form through the speaker 155-1.

The client module 151 may receive a request for obtaining information necessary for calculating a result corresponding to the user input from the intelligent server 200. According to an embodiment, the client module 151 may transmit the necessary information to the intelligent server 200 in response to the request.

The client module 151 may transmit information on the results of executing the plurality of actions according to the plan to the intelligent server 200. The intelligent server 200 may confirm that the received user input has been correctly processed using the information on the results.

The client module 151 may include a speech recognition module. According to an embodiment, the client module 151 may recognize a voice input for performing a limited function through the speech recognition module. For example, the client module 151 may execute an intelligent app for processing a voice input to perform an organic operation through a designated input (e.g., Wake up!).

The intelligent server 200 may receive information related to a user voice input from the electronic device 101 through a communication network. According to an embodiment, the intelligent server 200 may change data related to the received voice input into text data. According to an embodiment, the intelligent server 200 may generate a plan for performing a task corresponding to the user voice input based on the text data.

The plan may be generated by an artificial intelligence (AI) system. The AI system may be a rule-based system, or a neural network-based system (e.g., a feedforward neural network (FNN) or a recurrent neural network (RNN)). Alternatively, the AI system may be a combination thereof or other artificial intelligence systems. The plan may be selected from a set of predefined plans or may be generated in real time in response to a user request. For example, the artificial intelligence system may select at least one plan from among the predefined plans.

The intelligent server 200 may transmit a result according to the generated plan to the electronic device 101 or transmit the generated plan to the electronic device 101. According to an embodiment, the electronic device 101 may display the result according to the plan on the display. According to an embodiment, the electronic device 101 may display a result of executing an action according to the plan on the display.

The intelligent server 200 may include a front end 210, a natural language platform 220, a capsule database (DB) 230, an execution engine 240, an end user interface 250, a management platform 260, a big data platform 270, or an analytic platform 280.

The front end 210 may receive the received user input from the electronic device 101. The front end 210 may transmit a response corresponding to the user input.

The natural language platform 220 may include an automatic speech recognition (ASR) module 221, a natural language understanding (NLU) module 223, a planner module 225, a natural language generator (NLG) module 227, or a text-to-speech (TTS) module 229.

The ASR module 221 may convert the voice input received from the electronic device 101 into text data. The NLU module 223 may discern an intent of a user using the text data of the voice input. For example, the NLU module 223 may discern the intent of the user by performing syntactic analysis or semantic analysis on a user input in the form of text data. The NLU module 223 may discern the meaning of a word extracted from the user input using a linguistic feature (e.g., a grammatical element) of a morpheme or phrase, and determine the intent of the user by matching the discerned meaning of the word to an intent.

The planner module 225 may generate a plan using a parameter and the intent determined by the NLU module 223. The planner module 225 may determine a plurality of domains required to perform a task based on the determined intent. The planner module 225 may determine a plurality of actions included in each of the plurality of domains determined based on the intent. The planner module 225 may determine a parameter required to execute the determined plurality of actions or a result value output by the execution of the plurality of actions. The parameter and the result value may be defined as a concept of a designated form (or class). Accordingly, the plan may include a plurality of actions and a plurality of concepts determined by the intent of the user. The planner module 225 may determine a relationship between the plurality of actions and the plurality of concepts stepwise (or hierarchically). For example, the planner module 225 may determine an execution order of the plurality of actions determined based on the intent of the user, based on the plurality of concepts. In other words, the planner module 225 may determine the execution order of the plurality of actions based on the parameter required for the execution of the plurality of actions and results output by the execution of the plurality of actions. Accordingly, the planner module 225 may generate a plan including connection information (e.g., ontology) between the plurality of actions and the plurality of concepts. The planner module 225 may generate the plan using information stored in the capsule DB 230 that stores a set of relationships between concepts and actions.

The NLG module 227 may change designated information into a text form. The information changed to the text form may be in the form of a natural language utterance. The TTS module 229 may change information in a text form into information in a speech form.

According to an embodiment, some or all of the functions of the natural language platform 220 may be implemented in the electronic device 101 as well.

The capsule DB 230 may store information on the relationship between the plurality of concepts and actions corresponding to the plurality of domains. A capsule according to an embodiment may include a plurality of action objects (or action information) and concept objects (or concept information) included in the plan. According to an embodiment, the capsule DB 230 may store a plurality of capsules in the form of a concept action network (CAN). According to an embodiment, the plurality of capsules may be stored in a function registry included in the capsule DB 230.

The capsule DB 230 may include a strategy registry that stores strategy information necessary for determining a plan corresponding to a voice input. The strategy information may include reference information for determining one plan when there are a plurality of plans corresponding to the user input. According to an embodiment, the capsule DB 230 may include a follow-up registry that stores information on follow-up actions for suggesting a follow-up action to the user in a designated situation. The follow-up action may include, for example, a follow-up utterance. According to an embodiment, the capsule DB 230 may include a layout registry that stores layout information of information outputted through the electronic device 101. According to an embodiment, the capsule DB 230 may include a vocabulary registry that stores vocabulary information included in capsule information. According to an embodiment, the capsule DB 230 may include a dialog registry that stores information on a dialog (or an interaction) with the user. The capsule DB 230 may update the stored objects through a developer tool. The developer tool may include, for example, a function editor for updating an action object or a concept object. The developer tool may include a vocabulary editor for updating the vocabulary. The developer tool may include a strategy editor for generating and registering a strategy for determining a plan. The developer tool may include a dialog editor for generating a dialog with the user. The developer tool may include a follow-up editor for activating a follow-up objective and editing a follow-up utterance that provides a hint. The follow-up objective may be determined based on a current set objective, a preference of the user, or an environmental condition. In an embodiment, the capsule DB 230 may be implemented in the electronic device 101 as well.

The execution engine 240 may calculate a result using the generated plan. The end user interface 250 may transmit the calculated result to the electronic device 101. Accordingly, the electronic device 101 may receive the result and provide the received result to the user. The management platform 260 may manage information used by the intelligent server 200. The big data platform 270 may collect data of the user. The analytic platform 280 may manage a quality of service (QoS) of the intelligent server 200. For example, the analytic platform 280 may manage the components and processing rate (or efficiency) of the intelligent server 200.

The service server 300 may provide a designated service (e.g., a food order or hotel reservation) to the electronic device 101. According to an embodiment, the service server 300 may be a server operated by a third party. The service server 300 may provide information to be used for generating a plan corresponding to the received user input to the intelligent server 200. The provided information may be stored in the capsule DB 230. In addition, the service server 300 may provide result information according to the plan to the intelligent server 200.

In the integrated intelligence system 20 described above, the electronic device 101 may provide various intelligent services to the user in response to a user input. The user input may include, for example, an input through a physical button, a touch input, or a voice input.

The electronic device 101 may provide a speech recognition service through an intelligent app (or a speech recognition app) stored therein. In this example, the electronic device 101 may recognize a user utterance or a voice input received through the microphone, and provide a service corresponding to the recognized voice input to the user.

The electronic device 101 may perform a designated action alone or together with the intelligent server 200 and/or a service server 300, based on the received voice input. For example, the electronic device 101 may execute an app corresponding to the received voice input and perform a designated action through the executed app.

When the electronic device 101 provides a service together with the intelligent server 200 and/or the service server 300, the electronic device 101 may detect a user utterance using the microphone 150-1 and generate a signal (or voice data) corresponding to the detected user utterance. The electronic device 101 may transmit the voice data to the intelligent server 200 using the interface 177.

The intelligent server 200 may generate, as a response to the voice input received from the electronic device 101, a plan for performing a task corresponding to the voice input or a result of performing an action according to the plan. The plan may include, for example, a plurality of actions for performing a task corresponding to a voice input of a user, and a plurality of concepts related to the plurality of actions. The concepts may define parameters input to the execution of the plurality of actions or result values output by the execution of the plurality of actions. The plan may include connection information between the plurality of actions and the plurality of concepts.

The electronic device 101 may receive the response using the communication interface 177. The electronic device 101 may output a voice signal internally generated by the electronic device 101 to the outside using the speaker 155-1, or output an image internally generated by the electronic device 101 to the outside using the display module 160.

FIG. 3 is a diagram illustrating a form in which relationship information between concepts and actions is stored in a database according to one embodiment.

A capsule DB (e.g., the capsule DB 230) of the intelligent server 200 may store capsules in the form of a concept action network (CAN) 400. The capsule DB may store an action for processing a task corresponding to a voice input of a user and a parameter necessary for the action in the form of a CAN.

The capsule DB may store a plurality of capsules (a capsule A 401 and a capsule B 404) respectively corresponding to a plurality of domains (e.g., applications). According to an embodiment, one capsule (e.g., the capsule A 401) may correspond to one domain (e.g., a location (geo) or an application). Further, the one capsule may correspond to at least one service provider (e.g., CP 1 402 or CP 2 403) for performing a function for a domain related to the capsule. According to an embodiment, one capsule may include at least one action 410 for performing a designated function and at least one concept 420.

The natural language platform 220 may generate a plan for performing a task corresponding to the received voice input using the capsules stored in the capsule DB. For example, the planner module 225 of the natural language platform 220 may generate the plan using the capsules stored in the capsule DB. For example, a plan may be generated using actions 4011 and 4013 and concepts 4012 and 4014 of the capsule A 401 and an action 4041 and a concept 4042 of the capsule B 404.

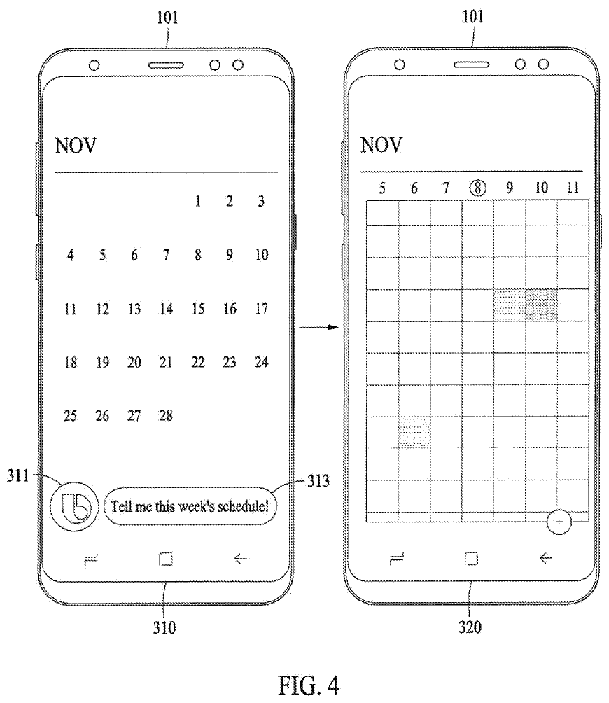

FIG. 4 describes an electronic device 101 receiving a voice input. The voice input can be followed by a designated voice input (such as “wake up”) which indicates to the electronic device 101 that a voice input will follow. In response to receiving the utterance, the electronic device 101 executes an intelligent app. The intelligent app can process the user input using an intelligent server 200. The intelligent app can also provide an interface that displays the voice input as text 313.

FIG. 4 is a diagram illustrating a screen of an electronic device processing a received voice input through an intelligent app according to one embodiment.

An electronic device (e.g., the electronic device 101 of FIG. 1) may execute an intelligent app to process a user input through an intelligent server (e.g., the intelligent server 200 of FIG. 2).

On a screen 310, when a designated voice input (e.g., Wake up!) is recognized or an input through a hardware key (e.g., a dedicated hardware key) is received, the electronic device 101 may execute an intelligent app for processing the voice input. The electronic device 101 may execute the intelligent app, for example, in a state in which a scheduling app is executed. According to an embodiment, the electronic device 101 may display an object (e.g., an icon) 311 corresponding to the intelligent app on the display module 160. According to an embodiment, the electronic device 101 may receive a voice input by a user utterance. For example, the electronic device 101 may receive a voice input of “Tell me this week's schedule!”. According to an embodiment, the electronic device 101 may display a user interface (UI) 313 (e.g., an input window) of the intelligent app in which text data of the received voice input is displayed on the display.

On a screen 320, the electronic device 101 may display a result corresponding to the received voice input on the display. For example, the electronic device 101 may receive a plan corresponding to the received user input, and display “this week's schedule” on the display according to the plan.

It is noted that applications in the electronic device 101 are frequency subject to revisions and updates. Moreover, the server may also execute the same applications. Certain embodiments provide a consistent response to user utterance, even where the electronic device 101 and the server have different app versions.

When a user utterance is received, the electronic device 101 determines whether the application information and goal information for the application that processes the user utterance indicates a latest version. The subject for processing the user utterance is the electronic device 101, unless, the application information and goal information do not indicate the latest version, but the electronic device can support the latest version. In which case, it is the server. Otherwise, the subject is the electronic device 101.

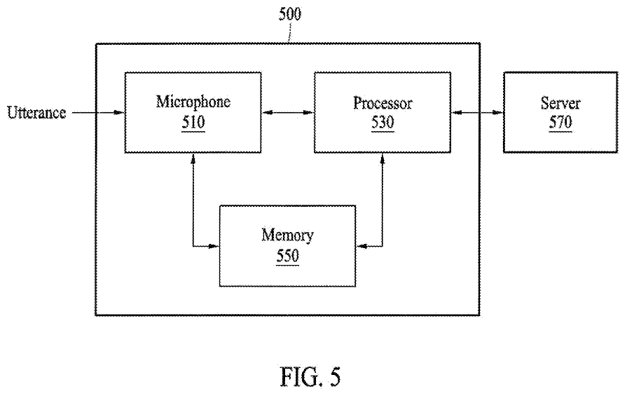

FIG. 5 is a block diagram illustrating an electronic device according to one embodiment.

Referring to FIG. 5, according to one embodiment, an electronic device 500 (e.g., the electronic device 101 of FIG. 1 or FIG. 2) may process an utterance of a user. The electronic device 500 may generate a processing result by processing a voice input of the user and may provide the generated processing result to the user.

The electronic device 500 may perform an update on the electronic device 500 using a server (e.g., the server 108 of FIG. 1 or the intelligent server 200 of FIG. 2). The electronic device 500 may provide the latest version of the utterance processing service to the user by maintaining the latest version of an application (or, an app) or a goal of the application.

The electronic device 500 may include a microphone 510 (e.g., the microphone 150-1 of FIG. 2), a processor 530 (e.g., the processor 120 of FIG. 1), and a memory 550 (e.g., the memory 130 of FIG. 1). The microphone 510 may receive an audio signal including an utterance of a user. The microphone 510 may output the received audio signal to the processor 530.

The processor 530 may process data stored in the memory 550. The processor 530 may execute computer-readable code (e.g., software) stored in the memory 550 and instructions triggered by the processor 530. The processor 530 may be a hardware-implemented data processing device having a circuit that is physically structured to execute desired operations. For example, the desired operations may include code or instructions included in a program.

The hardware-implemented data processing device may include a microprocessor, a central processing unit (CPU), a processor core, a multi-core processor, a multiprocessor, an application-specific integrated circuit (ASIC), and/or a field-programmable gate array (FPGA).

The processor 530 may obtain information on an application and information on a goal for processing an utterance based on an audio signal. The information on the application may include version information of the application, and the information on the goal may include version information of the goal. The version information may include information indicating the number of times any software has been revised.

The processor 530 may determine a subject for processing an utterance based on the information on the application, the information on the goal, and/or the version information received from a server 570. The subject for processing the utterance may include the electronic device 500 or the server 570. The processor 530 may determine whether the electronic device 500 can process the utterance based on the information on the application, the information on the goal, and/or the version information received from the server 570.

The processor 530 may determine whether the information on the application and/or the information on the goal indicate a latest version, based on the version information received from the server 570. The processor 530 may determine the subject for processing the utterance based on a result of the determination of whether the information indicates a latest version.

When the information on the application and the information on the goal indicate a latest version, the processor 530 may determine that the subject for processing the utterance is the electronic device 500.

When the information on the application and the information on the goal do not indicate a latest version, the processor 530 may determine whether the latest version is supported by the electronic device 500. The electronic device determines the subject for processing the utterance, based on whether the latest version can be supported.

When the information on the application and the information on the goal do not indicate the latest version and the latest version is supported by the electronic device 500, the processor 530 may determine that the subject for processing the utterance is the server 570. When the information on the application and the information on the goal do not indicate the latest version and the latest version is not supported by the electronic device 500, the processor 530 may determine that the subject for processing the utterance is the electronic device 500.

When the subject for processing the utterance is determined to be the server, the processor 530 may inform the user that the subject for processing the utterance is the server 570, using a UI.

The processor 530 may determine whether to update the information on the application and the information on the goal based on the version information, the information on the application, and the information on the goal. The processor 530 may perform an update on the information on the application and the information on the goal based on whether the electronic device 500 can process the utterance.

The processor 530 may determine whether the information on the application and the information on the goal indicate that latest version based on the version information received from the server 570. The processor 530 may determine whether to update the information on the application and the information on the goal based on a result of the determination of whether the information is the latest information. In certain embodiments, the application is updated with the latest version, whenever the information on the application and the information on the goal are updated.

The processor 530 may compare an utterance processing performance of the electronic device 500 with an utterance processing performance of the server 570. The processor 530 may determine whether to update the information on the application and the information on the goal based on a result of the comparison of the utterance processing performance. The utterance processing performance may include the accuracy of the utterance processing or the speed of the utterance processing.

The memory 550 may store instructions executable by the processor 530. The memory 550 may store usage information in the electronic device 500. The memory 550 may store instructions (or programs) executable by the processor 530. For example, the instructions may include instructions for performing an operation of the processor 530 and/or an operation of each component of the processor 530.

The memory 550 may be implemented as a volatile memory device or a non-volatile memory device. The volatile memory device may be implemented as a dynamic random-access memory (DRAM), a static random-access memory (SRAM), a thyristor RAM (T-RAM), a zero capacitor RAM (Z-RAM), or a twin transistor RAM (TTRAM).

The non-volatile memory device may be implemented as an electrically erasable programmable read-only memory (EEPROM), a flash memory, a magnetic RAM (MRAM), a spin-transfer torque (STT)-MRAM, a conductive bridging RAM (CBRAM), a ferroelectric RAM (FeRAM), a phase change RAM (PRAM), a resistive RAM (RRAM), a nanotube RRAM, a polymer RAM (PoRAM), a nano-floating gate memory (NFGM), a holographic memory, a molecular electronic memory device), or an insulator resistance change memory.

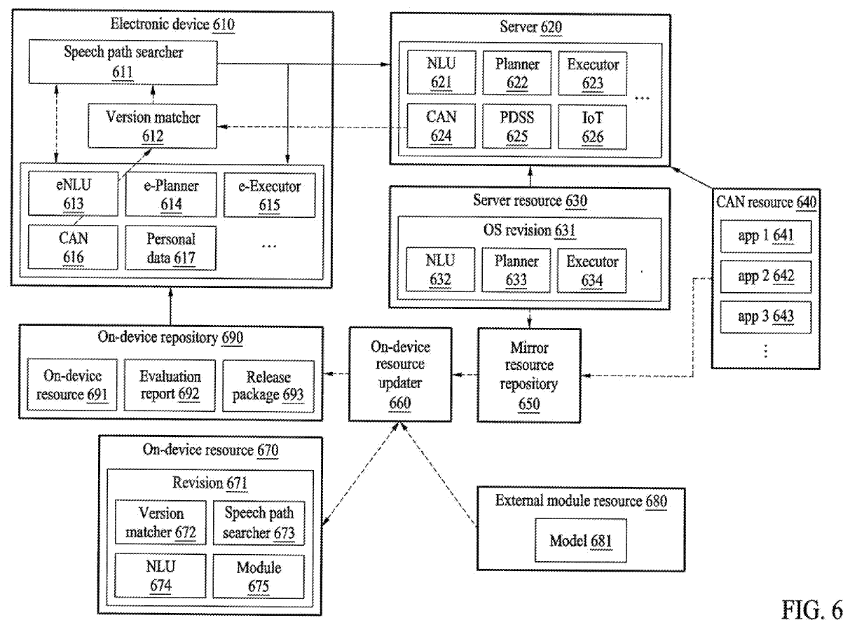

FIG. 6 is an example of a configuration of an utterance processing system according to one embodiment.

Referring to FIG. 6, according to one embodiment, an electronic device 610 (e.g., the electronic device 500 of FIG. 5) may process an utterance of a user. The electronic device 610 may receive version information from a server 620 (e.g., the server 570 of FIG. 5). The electronic device can determine a subject for processing the utterance using the received version information.

Updating a model while keeping the server 620 and the electronic device 610 in sync (or synchronized) may directly affect the user experience and the utterance processing performance. When the server 620 and the electronic device 610 are not in sync because a revision occurred in the server 620 and the electronic device 610, the electronic device 610 may maintain the latest version by making a request to sync the server 620 and the electronic device 610.

When an utterance of a user is received, the electronic device 610 may process the utterance with the latest version of a voice assistant service, using version information of the server 620 and the electronic device 610. This provides the latest version of the user experience. The electronic device 610 may efficiently process the received utterance even in a state in which the server 620 and the electronic device 610 are not in sync and there is a difference in version information.

The electronic device 610 may include a speech path searcher 611, a version matcher 612, an embedded natural language unit (eNLU) 613, an e-planner 614, an e-executor 615, and a CAN 616 and/or personal data 617. The speech path searcher 611 may acquire information on an application and information on a goal.

The speech path searcher 611 may output the acquired information on the application and information on the goal to the version matcher 612. The version matcher 612 may search for version information corresponding to the information on the application and the information on the goal in the server 620. The version matcher 612 may output the retrieved information to the speech path searcher 611. The version matcher 620 may also inquire as to the device model and device version of the electronic device 610 and output the retrieved information to the speech path searcher 611. The speech path searcher 611 may determine whether the information on the application and the information on the goal indicate the latest version by comparing the information on the application and the information on the goal with the version information received from the server 620.

The personal data 617 may include personalized data possessed by the electronic device 610. Data included in the personal data 617 may be used to manage private data that is not shared with the server 620. For example, the personalized data may include app usage time, number of touches, or biometric information (e.g., fingerprint information).

The server 620 may include an NLU 621, a planner 622, an executor 623, a CAN 624, a personal data sync service (PDSS) 625, and/or an Internet of Things (IoT) 626. The server 620 may process an utterance using information received from a CAN resource 640 and a server resource 630. The CAN resource 640 may include a plurality of apps 641, 642, and 643.

The eNLU 613, the e-planner 614, and the e-executor 615 may operate in the same manner as the NLU module 223, the planner module 225, and the execution engine 240 of FIG. 2, respectively.

The server 620 may receive information on CAN resources for each of the apps (e.g., app 1 641, app 2 642, and app 3 643) and applications supported by the electronic device 610, from the CAN resource 640. In this embodiment, the number of apps of the CAN resource 640 may differ depending on whether the electronic device 610 supports the applications.

The server resource 630 may include an OS revision 631, and the OS revision 631 may include an NLU 632, a planner 633, and/or an executor 634. An on-device resource 670 may include a revision 671, and the revision 671 may include a version matcher 672, a speech path searcher 673, an NLU 674, and/or a module 675. An on-device repository 690 may include an on-device resource 691, an evaluation report 692, and/or a release package 693.

The electronic device 610 may provide the same processing results to a user when the electronic device 610 processes an utterance and when the server 620 processes an utterance. The electronic device 610 may process an utterance using the stored personal information. The electronic device 610 may stay in sync with the server 620 to provide a consistent user experience. When fluctuation occurs in the server 620 or applications (or application models), the electronic device 610 sync using a mirror resource repository 650 and an on-device resource updater 660. An application model may be synced to the electronic device 610 before the application model is synced to the server 620. The electronic device 610 may determine a subject to process a received utterance of a user, using the synced information.

The on-device resource updater 660 may perform syncing based on information received from the on-device resource 670 and an external module resource 680. The on-device resource 670 may include the revision 671, and the revision 671 may include the version matcher 672, the speech path searcher 673, the NLU 674, and the module 675. The external module resource 680 may include a model 681.

The mirror resource repository 650, the on-device resource updater 660, the on-device resource 670, the external module resource 680, and the on-device repository 690 may manage and update binary images.

The mirror resource repository 650 may be a repository that receives code, a setting, or pieces of CAN data of the server 620. The mirror resource repository 650 may separately create and run a server image via data (e.g., an image) received from the server 620. In other words, the mirror resource repository 650 may run a replicate image and a replicate server. The mirror resource repository 650 may compare the performance of the electronic device 610 with a performance result obtained by running a test case (TC) of the server 620.

The on-device resource 670 may be a repository including pieces of code for each development module inserted into the electronic device 610.

The external module resource 680 may include an abstract description of a resource of an additional module inserted into the electronic device 610 in addition to the server 620. For example, for the purpose of adding anew type of NL to the electronic device 610, the external module resource 680 may receive a piece of code and/or an image related to the new type of NL from an external source.

The on-device resource updater 660 may extract a portion different from the existing information from information on the server 620 and the CAN 624 transmitted from the mirror resource repository 650, information obtainable by running the server 620 (e.g., setting information of the server 620), external open information of the external module resource 680, support code information, and development-related code received from the on-device resource 670, and apply it to the on-device resource 670. The on-device resource updater 660 may perform modification and management according to a change in the server 620 or a change in the external module resource 680 to identify and extract differences between information.

After the on-device resource 670 is updated such that it matches the existing information when there are differences in information as described above, the on-device repository 690 may manage an image (e.g., APK) that can be applied to the actual electronic device 610. The on-device repository 690 may be a repository that manages an installation image of the electronic device 610 and manages aversion. The on-device repository 690 may compare the performance of the electronic device 610 with the performance of a replicate server generated by the server 620 or the mirror resource repository 650, and manage based on the performance result.

The electronic device 610 may process an utterance based on information received from the on-device repository 690. The on-device repository 690 may include an on-device resource 691, an evaluation report 692, and a release package 693.

When the electronic device 610 receives an utterance of the user, the electronic device 610 may analyze the utterance via the eNLU 613 to obtain information on an application for processing the utterance and information on a goal for processing the utterance. The information on the goal may be in the form of <major number/revision number>.<minor number/issue number>.<patch number>. For example, the information on the goal may be in the form of version 1.01.1002 or version 2.07.31. The information on the goal may be managed in the form in which <status code> is additionally added. For example, the information on the goal may be in a form such as, version 1.01.1002-release3 or version 1.03.1007-beta2. The information on the goal may be expressed by numbers and/or letters after a goal value or number. For example, the information on the goal may be in a form such as, settings-goal3-01 or gallery-goal13-1A. The information on the goal may be indicated as a date based on an issuance date. For example, the information on the goal may be in a form such as setting_goal07_20210721 in which numbers such as 20210623 or 20210723 are added after the above-described goal information.

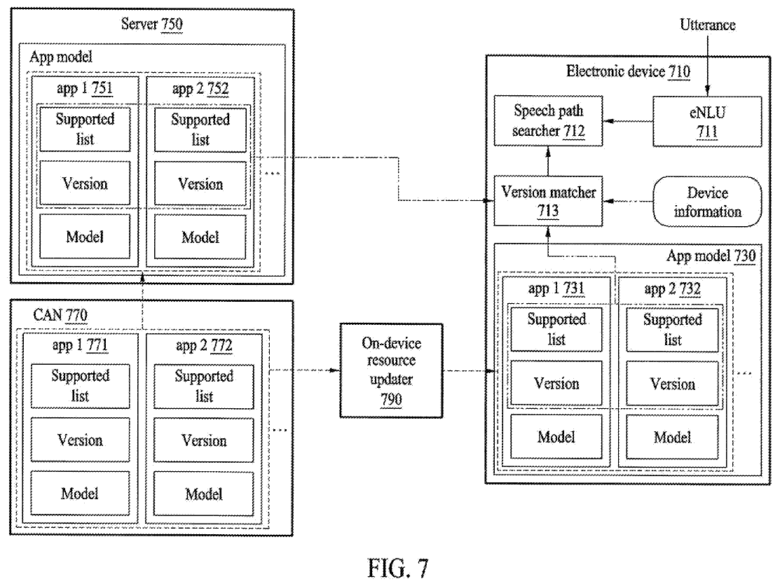

FIG. 7 is a diagram illustrating an operation of comparing information between an electronic device and a server according to one embodiment. It can be seen that, at the least, from comparing the information on the application and the information on the goals, electronic device 710 does not have the latest version of the application.

Referring to FIG. 7, according to one embodiment, an electronic device 710 (e.g., the electronic device 500 of FIG. 5) may receive version information from a server 750 (e.g., the server 570 of FIG. 5) and process an utterance. The electronic device 710 may perform an update on information on an application and information on a goal of the electronic device 710 based on the version information received from the server 750.

The electronic device 710 may include an eNLU 711 (e.g., the eNLU 613 of FIG. 6), a speech path searcher 712 (e.g., the speech path searcher 611 of FIG. 6), a version matcher 713 (e.g., the version matcher 612 of FIG. 6), and an app model 730. The app model 730 may include a plurality of apps (e.g., app 1 731 and app 2 732). The plurality of apps (e.g., app 1 731 and app 2 732) may include a list of supported a device, a version, and/or a model.

The server 750 may include the app model 730 including a plurality of apps (e.g., app 1 751 and app 2 752). A CAN 770 may include a plurality of apps (e.g., app 1 771 and app 2 772). The CAN 770 may output data related to the plurality of apps to the electronic device 710 via an on-device resource updater 790.

The eNLU 711 may receive an utterance of a user, recognize the information on the application and the information on the goal, and output the information to the speech path searcher 712. The speech path searcher 712 may output the information on the application and the information on the goal to the version matcher 713. The version matcher 713 may search for version information in the server 750 based on the information on the application and the information on the goal, and return the version information to the speech path searcher 712. The version matcher 713 may also inquire as to a device model and a device version of the electronic device 710 together and output the retrieved information to the speech path searcher 712.

The speech path searcher 712 may determine whether the information on the application and the information on the goal are the latest information by comparing the information on the application and the information on the goal with the version information received from the server 750. By comparing the information on the application and the information on the goal with the version information received from the server 750, the speech path searcher 712 may determine that the electronic device 710 shall process the utterance when the application is a target version such that the utterance can be processed by the electronic device 710, even if the application on the server 750 is the latest version. When both the latest version of the application and the goal is on the server 750, the speech path searcher 712 may determine whether the latest version of the application and the goal is supported by the electronic device 710 based on the device model and device version of the electronic device 710. When the latest version of the application and the goal is not supported by the electronic device 710, the speech path searcher 712 may determine that the electronic device 710 shall process the utterance.

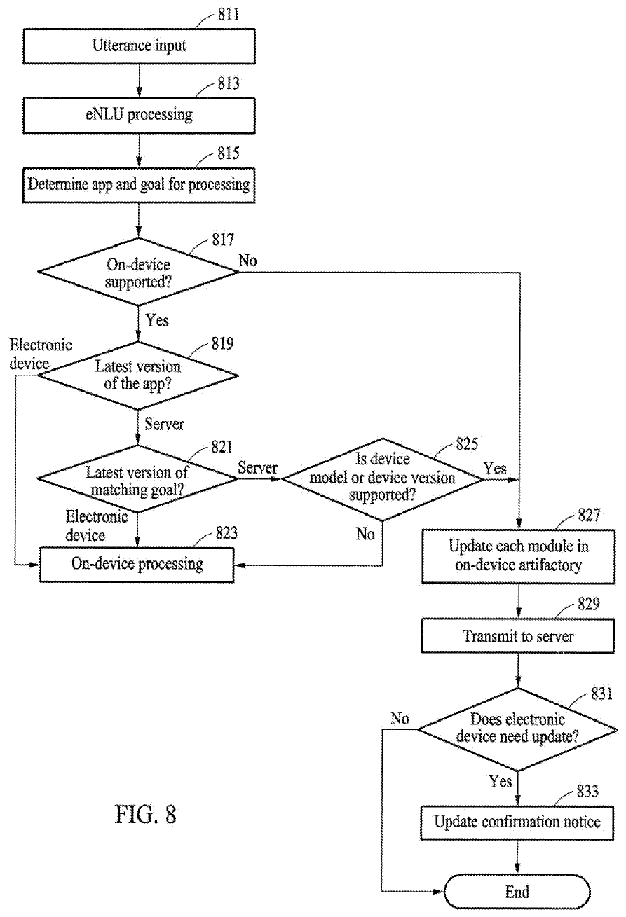

FIG. 8 is a flowchart illustrating an utterance processing operation of an electronic device according to one embodiment.

Referring to FIG. 8, in operation 811, a processor (e.g., the processor 530 of FIG. 5) may receive an utterance via a microphone (e.g., the microphone 510 of FIG. 5). In operation 813, the processor 530 may process an utterance input through an eNLU (e.g., the eNLU 613 of FIG. 6). In operation 815, the processor 530 may determine an application (or app) and a goal for processing an utterance.

In operation 817, the processor 530 may determine whether the application for processing the utterance and the goal are on-device supported by an electronic device (e.g., the electronic device 500 of FIG. 5) via a speech path searcher (e.g., the speech path searcher 611 of FIG. 6). When there is on-device support, the speech path searcher 611 may transmit the information on the application and the information on the goal to a version matcher (e.g., the version matcher 612 of FIG. 6) and inquire as to the application model information on the server 570 based on the application model information of the electronic device 500. The version matcher 612 may inquire as to the device model information and version information and return the retrieved information to the speech path searcher 611.

In operation 819, the processor 530 may determine whether the latest version of the application to process an utterance is on a server (e.g., the server 570 of FIG. 5) or the electronic device 500 via the speech path searcher 611. The processor 530 may determine the latest version of a device by comparing the information on the application on the electronic device 500 with the information on the application on the server 570.

When the latest version of the application is on the server 570, in operation 821, the processor 530 may determine whether the latest version of a matching goal is on the electronic device 500 or the server 570. When the latest version of the matching goal is on the electronic device 500, in operation 823, the processor 530 may perform on-device processing by determining that a subject for processing the utterance is the electronic device 500.

When the latest version of the matching goal is on the server 570, in operation 825, the processor 530 may determine whether the device model or device version is supported. When the latest version of the application is on the electronic device 500 or the device model or device version is not supported, in operation 823, the processor 530 may perform on-device processing by determining that the subject for processing the utterance is the electronic device 500.

When the latest version is on the server 570, in operation 825, the processor 530 may determine whether the latest version of the application and/or the goal is supported by the device model or device version of the electronic device 500. When the latest version of the application and/or the goal is not supported by the device model or device version of the electronic device 500, in operation 823, the processor 530 may perform on-device processing by determining that the subject for processing the utterance is the electronic device 500. Depending on the device model or device version, the electronic device 500 may not support the application model, in which case, the electronic device 500 will still attempt to process the utterance, even when the latest version of the application and the goal is on the server 570. For example, when the received utterance is “Change the refresh rate to 120”, even if the application and the goal is supported by the electronic device 500, if the electronic device 500 is not the latest version and thus does not support a refresh rate of 120, the utterance cannot be processed even if it is transmitted to the server 570. In that case, the electronic device 500 attempts to process the utterance and provides the user with an operation failure message explaining the reason for the failure.

When the application and the goal for processing the utterance are not on-device supported in operation 817, or supported by the device model or the device version in operation 825, in operation 827, the processor 530 may update each module in an on-device artifactory. In operation 829, the processor 530 may transmit the utterance to the server 570 after the update.

In operation 831, the processor 530 may determine whether the electronic device 500 needs an update. In operation 833, the processor 530 may provide an update confirmation notice (or a notification) to the user and the process is terminated. If the electronic device 500 does not need an update, operation 833 is bypassed and the process is terminated.

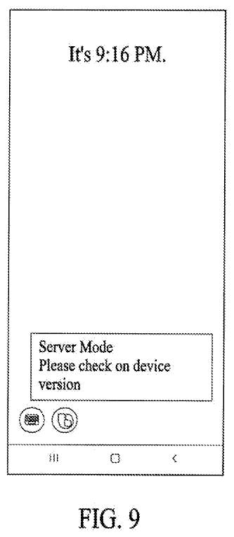

FIG. 9 is an example of a UI according to one embodiment.

Referring to FIG. 9, according to one embodiment, when a subject for processing an utterance is determined to be a server (e.g., the server 570 of FIG. 5), an electronic device (e.g., the electronic device 500 of FIG. 5) may inform a user that the subject for processing the utterance is the server 570, using the UI.

When an utterance is processed by the server 570, a processor (e.g., the processor 530 of FIG. 5) may inform the user that the currently input utterance is being processed by the server 570 via a display module (e.g., the display module 160 of FIG. 1) in the form of, for example, a pop-up window. The processor 530 may also provide a notification when the electronic device 500 needs an update.

In response to a user touching a pop-up, the processor 530 may display a screen on which information on an application or information on a goal of the electronic device 500 can be checked, or may display an update screen.

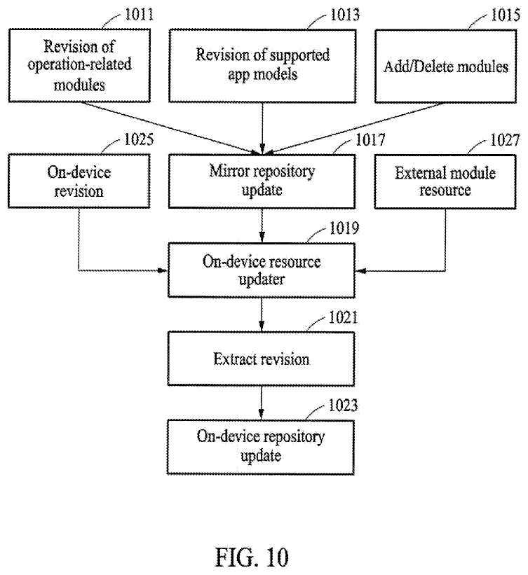

FIG. 10 is a flowchart illustrating a resource sync operation of an electronic device according to one embodiment.

Referring to FIG. 10, according to one embodiment, a processor (e.g., the processor 530 of FIG. 5) may compare resources in an electronic device (e.g., the electronic device 500 of FIG. 5) to determine a time point of a sync. A resource sync may be an operation of maintaining synchronization when there is a difference between an on-device resource and a server (e.g., the server 570 of FIG. 5) or other external modules.

In operation 1011, when operation-related modules are revised, or in operation 1013, when supported application models are revised, or in operation 1015, when a new module related to the electronic device 500 is added or deleted, the processor 530 may perform synchronization.

The processor 530 may periodically maintain the latest version of the electronic device 500 by applying a mirror repository update 1017 to the server 570, application models, and resources for all newly added or deleted modules.

In operation 1021, the processor 530 may extract a revised portion that is different between an on-device revision 1025 and an external module resource 1027 via an on-device resource updater 1019.

The processor 530 may perform a conversion operation so that raw data or processed data of the extracted revised portion may be updated to an on-device repository. In operation 1023, the processor 530 may perform an on-device repository update for the conversion operation. When a module, resource, or logic in the electronic device 500 changes, the processor 530 may reflect the change in the on-device repository via the on-device resource updater without additional processing.

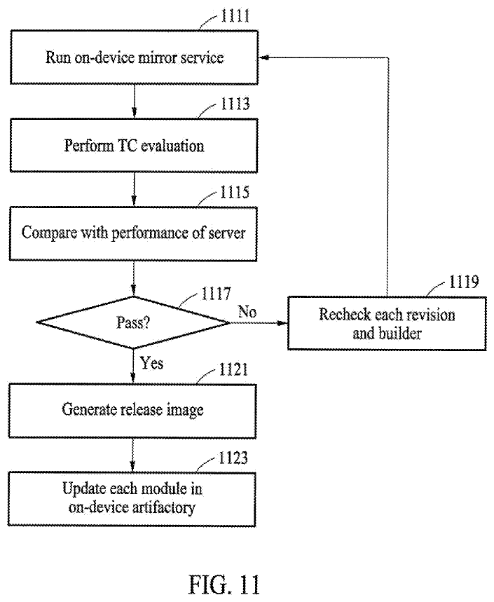

FIG. 11 is a flowchart illustrating an update operation of an electronic device according to one embodiment.

Referring to FIG. 11, according to one embodiment, a processor (e.g., the processor 530 of FIG. 5) may perform an update on an electronic device (e.g., the electronic device 500 of FIG. 5).

The processor 530 may compare an utterance processing performance of the electronic device 500 with an utterance processing performance of a server (e.g., the server 570 of FIG. 5). The processor 530 may determine whether to update the information on the application and the information on the goal based on a result of the comparison of the utterance processing performances. The utterance processing performance may include the accuracy of the utterance processing or the speed of the utterance processing.

The processor 530 may determine whether to release an image via a performance comparison with the server 570 after completing a modification of an on-device resource via a sync and update process.

In operation 1111, the processor 530 may run an on-device mirror service. In operation 1113, the processor 530 may perform a TC evaluation using the on-device mirror service. In operation 1115, the processor 530 may compare an utterance processing performance of the electronic device 500 with an utterance processing performance of the server 570 based on a result of the TC evaluation. Performance evaluation may be different according to policy. The processor 530 may compare the performance of the electronic device 500 with the performance of the server 570. The processor 530 may compare an utterance processing result of the electronic device 530 to which a synced image is applied with an utterance processing result of the server 570 using the server 570 and a CAN-related mirror resource repository (e.g., the mirror resource repository 650 of FIG. 6) or via an on-device resource updater (e.g., the on-device resource updater 660 of FIG. 6), to release an image when a result of the comparison is within a predetermined level. For example, the predetermined level may be about 90% to about 95%.

In operation 1121, when the performance evaluation is passed, the processor 530 may generate a release image. In operation 1119, when the performance evaluation is not passed, the processor 530 may recheck each revision and builder. In operation 1123, the processor 530 may update each module in an on-device artifactory. The processor 530 may manage resources, published images, and performance evaluation results.

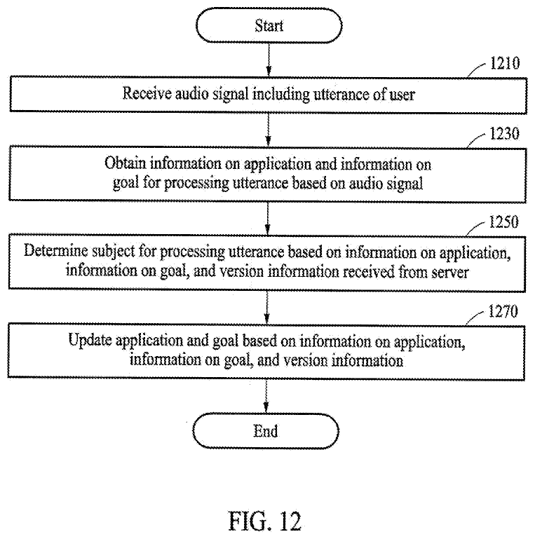

FIG. 12 is a flowchart illustrating an operation of an electronic device according to one embodiment.

Referring to FIG. 12, according to one embodiment, in operation 1210, a processor (e.g., the processor 530 of FIG. 5) may receive an audio signal including an utterance of a user using a microphone (e.g., the microphone 510 of FIG. 5).

According to one embodiment, in operation 1230, the processor 530 may obtain information on an application and information on a goal for processing an utterance based on an audio signal. The information on the application may include version information of the application, and the information on the goal may include version information of the goal.

In operation 1250, the processor 530 may determine a subject for processing an utterance based on the information on the application, the information on the goal, and the version information received from a server (e.g., the server 570 of FIG. 5). The processor 530 may determine whether the electronic device 500 can process the utterance based on the information on the application, the information on the goal, and the version information received from the server 570.

The processor 530 may determine whether the information on the application and the information on the goal are latest information based on the version information received from the server 570. The processor 530 may determine the subject for processing the utterance based on a result of the determination of whether the information indicates a latest version.

When the information on the application and the information on the goal are the latest information, the processor 530 may determine that the subject for processing the utterance is the electronic device 500.

When the information on the application and the information on the goal do not indicate the latest version, the processor 530 may determine whether the latest version is supported by the electronic device 500, and based on a result of the determination of whether the latest version can be supported, determine the subject for processing the utterance.

When the information on the application and the information on the goal do not indicate the latest version and the latest version is supported by the electronic device 500, the processor 530 may determine that the subject for processing the utterance is the server 570. When the information on the application and the information on the goal do not indicate the latest version and the latest version is not supported by the electronic device 500, the processor 530 may determine that the subject for processing the utterance is the electronic device 500.

When the subject for processing the utterance is determined to be the server, the processor 530 may inform the user that the subject for processing the utterance is the server 570, using a UI.

In operation 1270, the processor 530 may update the application and the goal based on the information on the application, the information on the goal, and the version information. The processor 530 may determine whether to update the information on the application and the information on the goal based on the version information, the information on the application, and the information on the goal. The processor 530 may perform an update on the information on the application and the information on the goal based on whether the electronic device 500 can process the utterance.

The processor 530 may determine whether the information on the application and the information on the goal are latest information based on the version information received from the server 570. The processor 530 may determine whether to update the information on the application and the information on the goal based on a result of the determination of whether the information is the latest information.

The processor 530 may compare an utterance processing performance of the electronic device 500 with an utterance processing performance of the server 570. The processor 530 may determine whether to update the information on the application and the information on the goal based on a result of the comparison of the utterance processing performance.

According to one embodiment, an electronic device (e.g., the electronic device 101 of FIG. 1) may include a microphone (e.g., the microphone 150-1 of FIG. 2), a processor (e.g., the processor 120 of FIG. 1), and a memory (e.g., the memory 130 of FIG. 1) for storing instructions executable by the processor, wherein execution of the instructions by the processor causes performance of a plurality of operations comprising: receiving an audio signal including an utterance of a user from the microphone; obtaining information on an application and information on a goal for processing the utterance, determining whether to process the utterance with the electronic device or a server, based on the information on the application, the information on the goal, and version information received from the server, determining whether to update the information on the application and the information on the goal based on the version information, the information on the application, and the information on the goal, when determining to process the utterance at the electronic device, processing the utterance at the electronic device, and when determining to process the utterance at the server, transmitting the utterance to the server.

According to one embodiment, the information on the application may include version information of the application, and the information on the goal may include version information of the goal.

According to one embodiment, the processor may determine whether the information on the application and the information on the goal indicate a latest version based on the version information received from the server, and determine whether to process the utterance at the electronic device or at the server based on a result of the determination.

According to one embodiment, when the information on the application and the information on the goal indicates a latest version, the processor may process the utterance at the electronic device.

According to one embodiment, when the information on the application and the information on the goal do not indicate the latest version, the processor may determine whether the latest version is supported by the electronic device, and based on a result of the determination, determine the subject for processing the utterance.

According to one embodiment, when the information on the application and the information on the goal do not indicate the latest version, and the latest version is supported by the electronic device, the processor may transmit the utterance to the server, and when the information on the application and the information on the goal do not indicate the latest version, and the latest version is not supported by the electronic device, processing the utterance at the electronic device.

According to one embodiment, when the subject for processing the utterance is determined to be the server, the processor may inform the user that the utterance is processed at the server, using a UI.

According to one embodiment, the processor may determine whether the information on the application and the information on the goal indicate a latest version based on the version information received from the server, and determine whether to update the information on the application and the information on the goal based on a result of the determination.

According to one embodiment, the processor may compare an utterance processing performance of the electronic device with an utterance processing performance of the server, and determine whether to update the information on the application and the information on the goal based on a result of the comparison.

According to one embodiment, an electronic device may include a microphone, a processor, and a memory storing instructions to be executed by the processor, wherein the processor may receive an audio signal including an utterance of a user from the microphone, obtain information on an application and information on a goal for processing the utterance, determine whether the electronic device can process the utterance based on the information on the application, the information on the goal, and version information received from a server, and update the information on the application and the information on the goal based on whether the processing is possible.

According to one embodiment, the information on the application may include version information of the application, and the information on the goal may include version information of the goal.

According to one embodiment, the processor may determine whether the information on the application and the information on the goal indicate a latest version based on the version information received from the server, and processing the utterance at the electronic device or the server based on a result of the determination.

According to one embodiment, when the information on the application and the information on the goal are the latest information, the processor may process the utterance.

According to one embodiment, when the information on the application and the information on the goal do not indicate the latest version, the processor may determine whether the latest version is supported by the electronic device, and based on a result of the determination, processing the utterance at the electronic device or the server.

According to one embodiment, when the information on the application and the information on the goal do not indicate the latest version, and the latest version is supported by the electronic device, the processor may transmit the utterance to the server, and when the information on the application and the information on the goal do not indicate the latest version, and the latest version is not supported by the electronic device, determine that processing the utterance at the electronic device.

According to one embodiment, when the subject for processing the utterance is determined as the server, the processor may inform the user that the utterance is processed at the server, using a UI.

According to one embodiment, the processor may determine whether the information on the application and the information on the goal indicate a latest version based on the version information received from the server, and update the information on the application and the information on the goal based on a result of the determination.

According to one embodiment, the processor may compare an utterance processing performance of the electronic device with an utterance processing performance of the server, and determine whether to update the information on the application and the information on the goal based on a result of the comparison.

According to one embodiment, an utterance processing method of an electronic device may include receiving an audio signal including an utterance of a user, obtaining information on an application and information on a goal for processing the utterance based on the audio signal, determining whether to process the utterance at an electronic device or a server based on the information on the application, the information on the goal, and version information received from the server, and determining whether to update the information on the application and the information on the goal based on the version information, the information on the application, and the information on the goal.

According to one embodiment, the information on the application comprises version information of the application, and the information on the goal comprises version information of the goal.

Although certain non-limiting embodiments have been presented with a degree of particularity, it shall be understood that the embodiments can be modified or revised, have certain features omitted, or other features added without departing from the scope of the disclosure. Accordingly, this disclosure is only limited by the following claims and equivalents thereof.

What is claimed is:

1. An electronic device, comprising:
a microphone;
a processor; and
a memory storing instructions executable by the processor, wherein execution of the instructions by the processor causes the processor to perform a plurality of operations comprising:
receiving an audio signal including an utterance of a user from the microphone;
obtaining information on an application and information on a goal for processing the utterance,
determining whether to process the utterance with the electronic device or with a server, based on the information on the application, the information on the goal, and version information received from the server,
determining whether to update the information on the application and the information on the goal based on the version information, the information on the application, and the information on the goal;
when determining to process the utterance at the electronic device, processing the utterance; and
when determining to process the utterance at the server, transmitting the utterance to the server.

2. The electronic device of claim 1, wherein the information on the application comprises version information of the application, and the information on the goal comprises version information of the goal.

3. The electronic device of claim 2, wherein the plurality of operations further comprises:
determining whether the information on the application and the information on the goal indicate a latest version based on the version information received from the server; and
wherein determining whether to process the utterance at the electronic device or at the server further comprises determining whether to process the utterance at the electronic device or at the server based on a result of the determination.

4. The electronic device of claim 3, wherein the plurality of operations further comprises:
in response to the information on the application and the information on the goal indicating the latest version, processing the utterance at the electronic device.

5. The electronic device of claim 3, wherein the plurality of operations further comprises:
in response to the information on the application and the information on the goal not indicating the latest version, determine whether the latest version is supported by the electronic device, and determining whether to process the utterance at the electronic device or the server, further comprises determining based on whether the latest version is supported by the electronic device.

6. The electronic device of claim 5, wherein the plurality of operations further comprises:
in response to the information on the application and the information on the goal not indicating the latest version, and the latest version being supported by the electronic device,
transmitting the utterance to the server; and
in response to the information on the application and the information on the goal not indicating the latest version, and the latest version not being supported by the electronic device,
processing the utterance at the electronic device.

7. The electronic device of claim 5, wherein the plurality of operations further comprises:
in response to a determination that the subject for processing the utterance is the server, inform a user that the utterance is processed at the server, using a user interface.

8. The electronic device of claim 1, wherein the plurality of operations further comprises:
determining whether the information on the application and the information on the goal indicates a latest version based on the version information received from the server; and
updating the information on the application and the information on the goal based whether the information on the application and the information on the goal indicates the latest version.

9. The electronic device of claim 1, wherein the plurality of operations further comprises:
comparing an utterance processing performance of the electronic device with an utterance processing performance of the server; and
updating the information on the application and the information on the goal based on a result of the comparison.

10. An electronic device, comprising:
a microphone;
a processor; and
a memory storing instructions that are executable by the processor, wherein execution of the instructions by the processor causes the processor to perform a plurality of operations comprising:
receiving an audio signal including an utterance of a user from the microphone; obtaining information on an application and information on a goal for processing the utterance,
determining whether the electronic device can process the utterance based on the information on the application, the information on the goal, and version information received from a server, and
updating of the information on the application and the information on the goal based on whether the processing is possible.

11. The electronic device of claim 10, wherein the information on the application comprises version information of the application, and the information on the goal comprises version information of the goal.

12. The electronic device of claim 11, wherein the plurality of operations further comprises:
determining whether the information on the application and the information on the goal indicate a latest version based on the version information received from the server; and
processing the utterance at the electronic device or a server based on a result of the determination.

13. The electronic device of claim 12, wherein the plurality of operations further comprises:
in response to the information on the application and the information on the goal being the latest information, processing the utterance at the electronic device.

14. The electronic device of claim 12, wherein the plurality of operations further comprises:
in response to the information on the application and the information on the goal not indicating a latest version, determine whether the latest version is supported by the electronic device, and processing the utterance at the electronic device or the server based on a result of the determination.

15. The electronic device of claim 14, wherein the plurality of operations further comprises:
in response to the information on the application and the information on the goal not indicating the latest version, and the latest version being supported by the electronic device, transmitting the utterance to the server; and
in response to the information on the application and the information on the goal not indicating the latest version, and the latest version not being supported by the electronic device, processing the utterance.

16. The electronic device of claim 14, wherein plurality of operations further comprises:
in response to a determination to process the utterance at the server, informing a user that the utterance is processed at the server, using a user interface.

17. The electronic device of claim 10, wherein the plurality of operations further comprises:
determining whether the information on the application and the information on the goal indicate a latest version, based on the version information received from the server; and
updating of the information on the application and the information on the goal based on a result of the determination.

18. The electronic device of claim 10, wherein to the plurality of operations further comprises:
comparing an utterance processing performance of the electronic device with an utterance processing performance of the server; and
determining whether to update the information on the application and the information on the goal based on a result of the comparison.

19. A method for processing an utterance, the method comprising:
receiving an audio signal including an utterance of a user;
obtaining information on an application and information on a goal for processing the utterance based on the audio signal;
determining whether to process the utterance at an electronic device or a server based on the information on the application, the information on the goal, and version information received from the server; and
determining whether to update the information on the application and the information on the goal based on the version information, the information on the application, and the information on the goal.

20. The method of claim 19, wherein the information on the application comprises version information of the application, and the information on the goal comprises version information of the goal.
